(19) United States
(12) Patent Application Publication
(10) Pub. No.: US 2010/0261373 A1
(43) Pub. Date: Oct. 14, 2010

(54) SWITCHED RECEPTACLE DEVICE WITH LED INDICATION

(76) Inventor: Michael D. Roneker, Portsmouth, NH (US)

Correspondence Address: MESMER & DELEAULT, PLLC, 1 NEW HAMPSHIRE AVE., SUITE 125, PORTSMOUTH, NH, 03801, US

(21) Appl. No.: 12/562,582

(22) Filed: Sep. 18, 2009

Related U.S. Application Data
(60) Provisional application No. 61/212,427, filed on Apr. 11, 2009.

(51) Int. Cl. H01R 3/00; H01R 43/20

(52) U.S. Cl. 439/488; 29/876

(57) ABSTRACT

A switched receptacle device with led indication made up of a standard two-outlet receptacle that has two respective hot terminals and two respective neutral terminals, a resistor electrically connected to a first outlet neutral terminal; an LED having a first lead and a second lead electrically connected by the LED first lead in series with the resistor, and the second lead electrically connected to a first outlet hot terminal; and a rectifier diode electrically connected in parallel across the LED first lead and second lead, whereby the LED is activated whenever a switch has energized a hot terminal.

### BACKGROUND

1. Field of the Invention

The present invention generally relates to 120 V duplex electrical receptacles found in 15A and 20A service.

2. Description of the Related Art

NEC code article 210.70 (A)(1) Exception No. 1 states that in other than kitchens and baths, one of more receptacles controlled by a wall switch shall be permitted in lieu of lighting outlets. This is typically accomplished by first wiring any device box intended to have a switched receptacle during the “rough wiring” phase with three-wire Romex or MC cable. Upon the “finish wiring” phase, the device boxes containing the provisions for switching means are ready to attach to the duplex receptacle.

On any residential, commercial, or spec grade receptacle, small tabs are located on both the hot and neutral terminal sides. A three-wire cable typically consists of a black, red, white, and bare copper ground. On the duplex receptacle, the tab on the hot side is broken off, separating the feeds for the top and bottom receptacles. The black wire is constantly hot, while the red is typically terminated on the wall switch load side. The red and black conductors may be positioned however the electrician desires, switching either the top or bottom receptacle.

Once all the duplex receptacles are installed, e.g. in a bedroom, there is no way for the average person to know which receptacles are switched. Many homes, apartments, condos, hotels, etc., are wired this way to save time in the “finish phase” by not having to hang light fixtures, install recessed light trims, and so forth. Numerous service calls to expensive electricians are placed every year by home buyers who think a room was wired with a dead wall switch, or simply cannot figure out why a receptacle has no power (since some electricians switch the entire duplex receptacle).

What is needed, therefore, is a device and method of easily determining whether a receptacle is switched or not.

### SUMMARY

The invention is a device and method that satisfies the need to easily determine whether an electrical receptacle is switched. A device according to the present invention may comprise a two-outlet switched receptacle wired with an LED that turns on when the corresponding switch energizes the circuit. More particularly, the device may comprise a standard two-outlet receptacle having two respective hot terminals and two respective neutral terminals, a resistor electrically connected to a first outlet neutral terminal; an LED having a first lead and a second lead electrically connected by the LED first lead in series with the resistor, and the second lead electrically connected to a first outlet hot terminal; and a rectifier diode electrically connected in parallel across the LED first lead and second lead, whereby the LED is activated whenever a switch has energized a hot terminal. These and other features, aspects, and advantages of the present invention will become better understood with regard to the following description, claims, and accompanying drawings.

### DRAWINGS

FIG. 1 is an orthogonal view of a top receptacle portion according to the present invention.

FIG. 2 is an orthogonal view of a bottom receptacle portion according to the present invention.

FIG. 3 is a plan view of an LED, rectifier diode, and resistor assembly according to the present invention.

FIG. 4 is a rear plan view of a switched duplex receptacle according to the present invention.

### DESCRIPTION

The invention in its simplest form comprises a two-outlet switched receptacle wired with an LED that turns on when the corresponding switch energizes the circuit. One example of specific circuitry that can perform this function comprises a standard two-outlet receptacle having two respective hot terminals and two respective neutral terminals, a resistor electrically connected to a first outlet neutral terminal; a light-emitting diode (“LED”) having a first lead and a second lead electrically connected by the LED first lead in series with the resistor, and the second lead electrically connected to a first outlet hot terminal; and a rectifier diode electrically connected in parallel across the LED first lead and second lead, whereby the LED is activated whenever a switch has energized a hot terminal. It is understood that other circuits can be designed to do the same function, and that they would fall within the coverage of this invention.

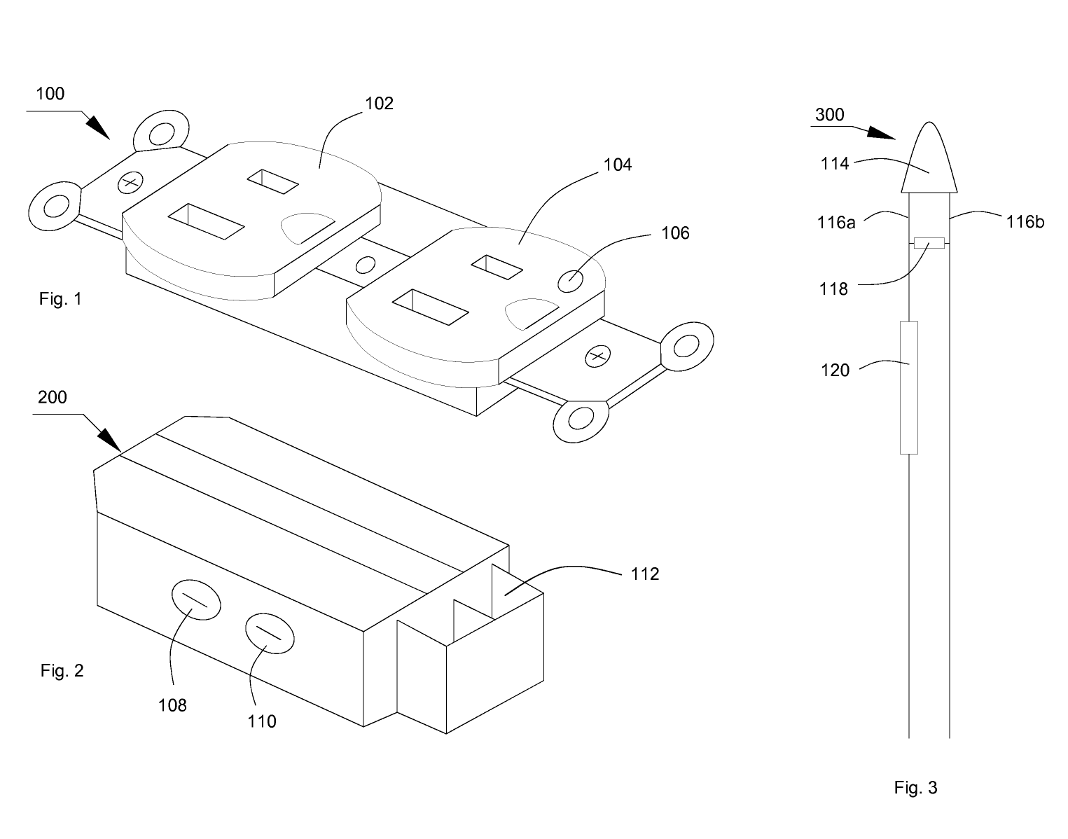

Turning to FIG. 1, a top receptacle portion 100 comprises a first two-prong outlet 104 and a second two-prong outlet 102. Preferably, the first outlet 104 and second outlet 102 are co-planar with the top receptacle portion 100. The top receptacle portion further comprises a through hole 106 for receiving the LED perpendicular to the plane of first outlet and second outlet.

The top receptacle portion 100 fits on top of a bottom receptacle portion 200 shown in FIG. 2. A first outlet neutral terminal 108 and second outlet neutral terminal 110 are shown in this view. Structure defining a recess 112 sized to receive an LED wired to a rectifier diode is provided in the bottom receptacle portion 200.

FIG. 3 shows the details of an LED assembly 300 having an LED 114 that has two leads 116a, 116b. The LED is preferably a 5 mm, 2.1 V, 30 mA LED. A green color LED is preferred but other colors can be used. Other LEDs could be used.

A resistor 120 is electrically connected in series to the LED first lead 116. The resistor 120 can be a nominal 33 k-ohm, ½ W, 5% tolerance resistor, but other resistors could be used.

A rectifier diode 118 is electrically connected in parallel with the LED leads 116a, 116b. The rectifier diode 118 can be a type IN4005 rectifier diode, but others could be used.

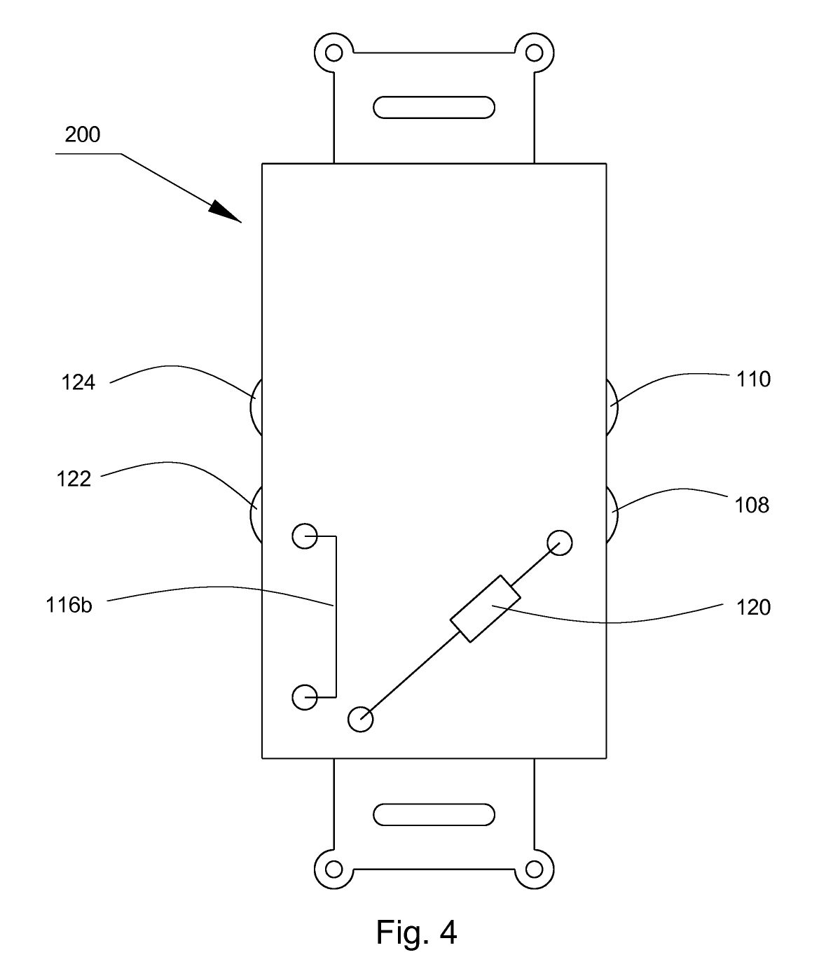

FIG. 4 shows the back of the switched duplex receptacle assembled according to the present invention. Although not shown, the first outlet 104 is electrically connected to a first outlet hot terminal 122 and a first outlet neutral terminal 108. The second outlet 102 is electrically connected to a second outlet hot terminal 124 and a second outlet neutral terminal 110.

The resistor end that is not connected to the LED first lead 116a is electrically connected to the first outlet neutral terminal 108. The second LED lead 116b is electrically connected to the first outlet hot terminal 122.

When wired as shown without the hot terminals electrically connected, a user turns can turn on a switch connected to the duplex receptacle, and the LED 114 will light up, indicating that the switch controls that first receptacle 104. Use of this circuit with an LED has many benefits. The circuit is simple to make and uses very little energy. The invention can be retrofitted into existing duplex receptacles. In fact the LED assembly 300 can be provided pre-assembled as a kit for installation in the field. In the alternative, switched receptacles can also be fabricated with this circuit built in.

A method of making the invention has the following steps. First, a switched duplex receptacle is provided comprising a first two-prong outlet 104 and a second two-prong outlet 102; a first outlet hot terminal 122 electrically connected to the first outlet 104; a first outlet neutral terminal 108 electrically connected to the first outlet; a second outlet hot terminal 124 electrically connected to the second outlet 102; and a second outlet neutral terminal 110 electrically connected to the second outlet 102. An LED 114 having two leads 116a, 116b is provided, as well as a resistor 120, and a rectifier diode 118.

Next, electrically connect the rectifier diode 118 in parallel across the two LED leads 116a, 116b. Then electrically connect the resistor in series with the first LED lead 116a.

Make a hole 106 in the receptacle 100 for receiving the LED 114 and rectifier diode 118. Since the preferred LED is a 5 mm LED, the hole 106 should be slightly larger than 5 mm in diameter. Insert the LED assembly 300 through the hole 106 so that the leads can be attached to terminals from the bottom.

Electrically connect the resistor 120 to the first outlet neutral terminal 108. Finally, electrically connect the second LED lead 116b to the first outlet hot terminal 122.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. A switched receptacle device with LED indication comprising:
a top receptacle portion comprising a first two-prong outlet and a second two-prong outlet;
a bottom receptacle portion comprising:
a first outlet hot terminal electrically connected to the first outlet;
a first outlet neutral terminal electrically connected to the first outlet;
a second outlet hot terminal electrically connected to the second outlet; and
a second outlet neutral terminal electrically connected to the second outlet;
a resistor electrically connected to the first outlet neutral terminal;
an LED comprising a first lead and a second lead electrically connected by the LED first lead in series with the resistor, and the second lead electrically connected to the first outlet hot terminal; and
a rectifier diode electrically connected in parallel across the LED first lead and second lead, whereby the LED is activated whenever a switch has energized a hot terminal.

2. The device of claim 2, wherein the resistor is a nominal 33 k-ohm resistor.

3. The device of claim 3, wherein the resistor is a 33 k, ½ W, 5% tolerance resistor.

4. The device of claim 1, wherein the LED is a 30 mA LED.

5. The device of claim 4, wherein the LED is a 5 mm, 2.1 V 30 mA LED.

6. The device of claim 1, wherein the first outlet and second outlet are co-planar with the top receptacle portion, the top receptacle portion further comprising a through hole for receiving the LED perpendicular to the plane of first outlet and second outlet.

7. The device of claim 6, the bottom receptacle portion further comprising a recess for receiving the LED and the rectifier diode within.

8. The device of claim 1, further comprising an electrically conductive tab electrically connecting the first outlet hot terminal and the second outlet hot terminal, whereby both the first outlet and second outlet hot terminals are energized simultaneously when switched on, and the LED indicates that both outlets are energized.

9. The device of claim 1 wherein the top receptacle portion and bottom receptacle portion comprise a unitary structure.

10. A method of making a switched receptacle device with LED indication comprising the steps of:
providing switched duplex receptacle comprising:
a first two-prong outlet and a second two-prong outlet;
a first outlet hot terminal electrically connected to the first outlet;
a first outlet neutral terminal electrically connected to the first outlet;
a second outlet hot terminal electrically connected to the second outlet; and
a second outlet neutral terminal electrically connected to the second outlet;
providing an LED having two leads;
providing a resistor;
providing a rectifier diode;
electrically connecting the rectifier diode in parallel across the two LED leads;
electrically connecting the resistor in series to a first LED lead;
making a hole in the receptacle for receiving the LED and rectifier diode;
electrically connecting the resistor to the first outlet neutral terminal; and
electrically connecting the second LED lead to the first outlet hot terminal; whereby the LED is activated whenever a switch has energized a hot terminal.

11. The method of claim 10, wherein the resistor is a nominal 33 kΩ resistor.

12. The method of claim 11, wherein the resistor is a 33 k-ohm, ½ W, 5% tolerance resistor.

13. The method of claim 10, wherein the LED is a 30 mA LED.

14. The method of claim 13, wherein the LED is a 5 mm, 2.1 V 30 mA LED.

15. A kit that when assembled makes a switched receptacle with LED indication comprising:
switched duplex receptacle comprising:
a first two-prong outlet and a second two-prong outlet;
a first outlet hot terminal electrically connected to the first outlet;
a first outlet neutral terminal electrically connected to the first outlet;
a second outlet hot terminal electrically connected to the second outlet; and
a second outlet neutral terminal electrically connected to the second outlet; and
an LED assembly comprising:
a resistor;
an LED comprising a first lead and a second lead electrically connected by the LED first lead in series with the resistor, and the second lead electrically connected to the first outlet hot terminal; and
a rectifier diode electrically connected in parallel across the LED first lead and second lead, whereby the LED is activated whenever a switch has energized a hot terminal when the kit is assembled.

16. The kit of claim 15, wherein the resistor is a nominal 33 k-ohm resistor.

17. The kit of claim 16, wherein the resistor is a 33 k-ohm, ½ W, 5% tolerance resistor.

18. The kit of claim 15, wherein the LED is a 30 mA LED.

19. The kit of claim 18, wherein the LED is a 5 mm, 2.1 V 30 mA LED.

20. A switched receptacle device with LED indication comprising:
a two-outlet electrical receptacle;
an electrical switch electrically connected to the receptacle; and
an LED electrically connected to the receptacle and switch so that the LED is energized only when the switch energizes the receptacle.
